(19) United States
(12) Patent Application Publication
(10) Pub. No.: US 2003/0191851 A1
(43) Pub. Date: Oct. 9, 2003

(54) Identifying and storing a target information unit contained in a received information stream

(76) Inventor: Henry Litzmann Edwards, Garland, TX (US)

Correspondence Address: TEXAS INSTRUMENTS INCORPORATED, P O BOX 655474, M/S 3999, DALLAS, TX, 75265

(21) Appl. No.: 10/348,637

(22) Filed: Jan. 22, 2003

Related U.S. Application Data
(60) Provisional application No. 60/360,970, filed on Feb. 28, 2002.

(51) Int. Cl. G06F 15/16

(52) U.S. Cl. 709/231

(57) ABSTRACT

In one embodiment of the present invention, a system for identifying and storing a target information unit, contained in a received information stream including multiple information units, according to a stored tag file corresponding to the target information unit, includes one or more stored tag files. Each tag file corresponds to a target information unit having a predetermined length and includes a first set of attributes associated with the corresponding target information unit. The system further includes a processor that accesses a digitized data stream representing the received information stream and extracts a second set of one or more attributes from a portion of the digitized data stream. The processor compares the second set of one or more attributes extracted from the portion of the digitized data stream with the first set of one or more attributes in a stored tag file and determines, according to the comparison, whether the portion of the digitized data stream includes the target information unit corresponding to the stored tag file. If so, the processor stores the portion of the digitized data stream including the target information unit, the stored portion having a length substantially equivalent to the predetermined length of the target information unit as specified in the stored tag file for the target information unit.

### TECHNICAL FIELD OF THE INVENTION

This invention relates generally to communications and data processing, and more particularly to identifying and storing a target information unit contained in a received information stream.

### BACKGROUND OF THE INVENTION

Persons encounter information in various forms and in various units on a regular basis. Songs, television programs, and movies are examples of information units persons frequently encounter. A person may desire to record one or more such information units for later playback. For example, a person may record a song broadcast from a radio station for later playback. Personally recording a song, however, often requires a person to monitor the radio airwaves until the desired song is played and, once the person identifies the desired song as the one currently being played, to attempt to record as much of the song as possible. This process may be time consuming, may result in a person missing the first few seconds of the song before beginning to record the song, and may result in the song being missed because the person can typically monitor only one radio station at a time. These and other deficiencies have made previous techniques for identifying and storing information units, such as songs, inadequate for many persons.

### SUMMARY OF THE INVENTION

According to the present invention, disadvantages and problems associated with previous recording systems may be reduced or eliminated.

In one embodiment of the present invention, a system for identifying and storing a target information unit, contained in a received information stream including multiple information units, according to a stored tag file corresponding to the target information unit, includes one or more stored tag files. Each tag file corresponds to a target information unit having a predetermined length and includes a first set of attributes associated with the corresponding target information unit. The system further includes a processor that accesses a digitized data stream representing the received information stream and extracts a second set of one or more attributes from a portion of the digitized data stream. The processor compares the second set of one or attributes extracted from the portion of the digitized data stream with the first set of one or more attributes in a stored tag file and determines, according to the comparison, whether the portion of the digitized data stream includes the target information unit corresponding to the stored tag file. If so, the processor stores the portion of the digitized data stream including the target information unit, the stored portion having a length substantially equivalent to the predetermined length of the target information unit as specified in the stored tag file for the target information unit.

Particular embodiments of the present invention may provide one or more technical advantages. For example, certain embodiments may allow a user to store within a user device one or more tag files each representing a corresponding target information unit the user desires to store. The device may monitor one or more broadcast radio signals, for example, for desired songs corresponding to the stored tag files, recording a song contained in a broadcast radio signal if the song is determined to correspond to a stored tag file based on a comparison of attributes extracted from the radio signal with attributes in the stored tag file. This may allow a user to record one or more songs contained in one or more broadcast radio signals without requiring the user to listen to the various radio signals and personally attempt to record desired songs. This may also prevent a user from missing a desired song because it is on a radio station the user is not monitoring or missing the first few seconds of the song before beginning to record it. In certain embodiments, users may be able to share tag files with other users using a server system, expanding the number of available tag files without requiring each user to personally construct all the tag files of interest to the user or maintain all such tag files at an associated user device. Users logged in or otherwise linked to the server system may be able to share tag files in a way that allows a user to access the server system, view tag files available for selection at that time, select a tag file, and download the selected tag file to an associated user device from the server system or, through the server system, from another user device at which the selected tag file is stored. In certain embodiments, the user device can play back the target information units identified and stored at the user device as desired.

Systems and methods incorporating one or more of these or other technical advantages may be well suited for modem communications and data processing environments. Certain embodiments of the present invention may provide all, some, or none of the above advantages. Certain embodiments may provide one or more other technical advantages that may be readily apparent to those skilled in the art from the figures, descriptions, and claims included herein.

### BRIEF DESCRIPTION OF THE DRAWINGS

For a more complete understanding of the present invention and the advantages thereof, reference is now made to the following descriptions, taken in conjunction with the accompanying drawings in which:

FIG. 1 illustrates an example communications environment including user devices and information streams;

FIG. 2 illustrates an example system associated with a user device and supporting identification and storage of one or more target information units contained in one or more received information streams; FIG. 3 illustrates example tag files for which the corresponding target information units are songs;

FIG. 4 illustrates an example method for identifying and storing one or more target information units contained in one or more received information streams; and

FIG. 5 illustrates an example method for sharing and downloading one or more tag files using a server system.

### DESCRIPTION OF EXAMPLE EMBODIMENTS

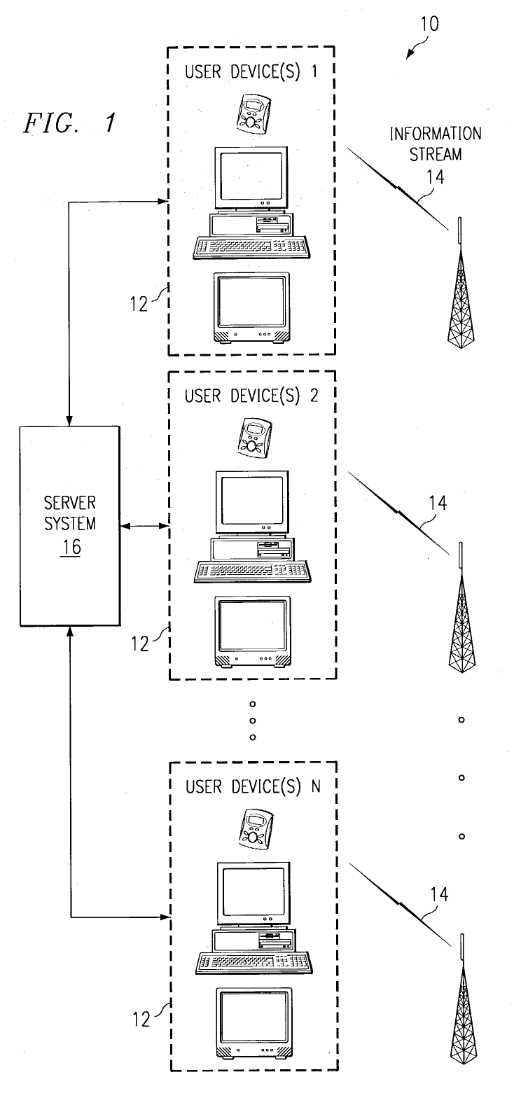

FIG. 1 illustrates an example communications environment 10 including user devices 12 and information streams 14. System 10 includes one or more user devices 12 that, in general, can each identify and store one or more target information units contained in one or more received information streams 14. Each information stream 14 typically includes multiple information units, any one or more of which may be target information units desired by associated users. Each target information unit has predetermined length and may be identified and stored according to a tag file corresponding to the target information unit and including a first set of attributes associated with the target information unit. In general, a user device 12 accesses a digitized data stream representing a received information stream 14, extracts a second set of one or more attributes from a portion of the digitized data stream, and compares the second set of one or more attributes extracted from the portion of the digitized data stream with the first set of one or more attributes in the stored tag file. According to the comparison, user device 12 determines whether the portion of the digitized data stream includes the target information unit. If so, user device 12 stores the portion of the digitized data stream including the target information unit, the stored portion of the digitized data stream having a length substantially equivalent to the predetermined length of the target information unit.

User devices 12 may include Motion Picture Expert Group (MPEG) Audio Layer 3 (MP3) players, computers, televisions, stereos, or any other suitable devices capable of identifying and storing a target information unit contained in a received information stream 14. Received information streams 14 may include one or more of the following: (1) a broadcast radio signal (including an amplitude modulation (AM) signal, frequency modulation (FM) signal, an Internet radio broadcast, or any other suitable broadcast radio signal); (2) a broadcast television signal (including a satellite signal, digital cable signal, or any other suitable broadcast television signal); (3) an audio signal (including a Wave (WAV) file, REAL AUDIO (RA) file, or any other suitable audio signal); (4) a video signal (including an MPEG file, audio/video interleaved (AVI) file, REAL VIDEO (RV) file, or any other suitable video signal); (5) or any other type of suitable signal for containing a target information unit to be identified and stored according to the present invention. Furthermore, received information stream 14 may include an analog signal, such as with the AM or FM broadcast radio signal for example, or a digital signal, such as with a broadcast Internet radio signal for example.

In the specific case where user device 12 includes an MP3 player, for example, received information stream 14 may be a broadcast radio signal such as an analog radio signal. In this example, the information units within received information stream 14 may be songs, and the target information unit desired by a user associated with user device 12 may be a desired song. A tag file corresponding to a desired song and stored at user device 12 may include a first set of measurable attributes of the song, for example: (1) the playing time or other predetermined length of the song; (2) one or more values for one or more target segments of the song, each value generated by applying a Fourier transform, wavelet transform, or other operation to the corresponding target segment; (3) one or more sequences of specific frequencies, corresponding to notes, within each of one or more target segments of the song; (4) average tempo within one or more target segments of the song; (5) any other suitable frequency, tempo, or other characteristics of each of one or more target segments of the song; and (6) any other information suitable for identifying the song, when compared with similar information in a second set of measurable attributes extracted from a portion of a digitized data stream representing a received information stream 14, and storing the song once it has been identified. User device 12 may store multiple tag files. Each tag file may correspond to a different song, or multiple tag files may correspond to the same song, according to particular needs. Tag files are described in more detail below with reference to FIG. 3.

The MP3 player in this example may “listen” to the broadcast radio signal, extracting a second set of measurable attributes from each consecutive segment of the signal it “hears” and comparing the extracted second set of attributes for each consecutive segment with first sets of attributes contained in one or more tag files stored at user device 12. For example, each consecutive segment of the signal may correspond to a time window having a fixed length (e.g., five seconds). If the MP3 player determines that the broadcast radio signal to which it is “listening” includes the song corresponding to the tag file, then the MP3 player determines the portion of the broadcast radio signal corresponding to the song and stores that portion of the broadcast radio signal for later playback. Although identifying and storing a song is described as a particular example, the present invention contemplates identifying and storing any suitable target information unit that may be included in a received information stream 14.

As another example, user device 12 may include a television, and received information stream 14 may be a broadcast television signal such as a digital cable television signal. In this example, the information units within received information stream 14 may be television programs, and the target information unit desired by a user associated with user device 12 may be a particular television program. A tag file corresponding to a desired television program and stored at user device 12 may include a first set of measurable attributes of the television program, for example: (1) the playing time or other predetermined length of the television program; (2) one or more values for each of one or more target segments of the television program, each value generated by applying a Fourier transform, wavelet transform, or other operation to the corresponding target segment; (3) one or more sequences of specific frequencies, corresponding to notes, within each of one or more target segments of the television program; (4) average tempo of one or more target segments of the television program; (5) any other suitable frequency, tempo, or other characteristic; and (6) any other information suitable for identifying the television program, when compared with similar information in a second set of measurable attributes extracted from a portion of a digitized data stream representing a received information stream 14, and storing the television program once it has been identified. User device 12 may store multiple tag files. Each tag file may correspond to a different television program, or multiple tag files may correspond to the same television program, according to particular needs.

The television in this example may “listen” to the broadcast television signal, extracting a second set of measurable attributes from each consecutive segment of the signal it “hears” and comparing the extracted second set of attributes for each consecutive segment with first sets of attributes contained in one or more tag files stored at user device 12. For example, each consecutive segment of the signal may correspond to a time window having a fixed length (e.g., five seconds). If the television determines that the broadcast television signal to which it is “listening” includes the television program corresponding to the tag file, then the television determines the portion of the broadcast television signal corresponding to the television program and stores that portion of the broadcast television signal for later playback.

In one embodiment, system 10 may include a server system 16 through which one or more tag files external to user devices 12 may be obtained for storage at user devices 12. One or more tag files external to a user device 12 may be stored at server system 16, such that user device 12 may obtain a tag file by downloading it from server system 16. In addition or as an alternative, one or more tag files external to a user device 12 may be stored external to server system 16, at other user devices 12 associated with other users for example, such that user device 12 may obtain a tag file via server system 16 from another user device 12 linked at least temporarily to server system 16. For example, in an embodiment of system 10 including multiple user devices 12 and in which user devices 12 include computers, each user device 12 may store one or more tag files and users logged in or otherwise linked to server system 16 may share tag files in a manner that allows a user to access server system 16, view tag files available for selection at that time, select a tag file, and download the selected tag file through server system 16 from the user device 12 at which the selected tag file is stored.

Allowing users to obtain tag files using server system 16 may be advantageous because it may allow users to share already constructed tag files. As a result, a user may not be required to personally construct each tag file for each target information unit a user desires. For example, if the target information units are songs, a user may obtain the tag file for one or more songs without personally generating and entering the necessary attributes for each corresponding tag file. As another advantage, sharing tag files may provide users a greater selection of tag files, increasing the opportunity to obtain desired target information units. Furthermore, sharing tag files may allow a user to browse a selection of tag files corresponding to a particular target information unit to obtain the tag file having the highest quality. A user may also be able to download desired tag files (either from other user devices 12 using server system 16 or directly from server system 16), use the tag file to obtain the desired target information unit, and then discard the tag file to free up associated storage space on user device 12.

Server system 16 may operate on one or more computers at one or more locations. Server system 16 may include one or more partitions on one or more existing servers or one or more separate servers within the infrastructure of one or more enterprises, such as Hypertext Transfer Protocol (HTTP), File Transfer Protocol (FTP), mail, or other Internet-enabled servers. Each user device 12 may be coupled to server system 16 using one or more computer buses, local area networks (LANs), metropolitan area networks (MANs), wide area networks (WANs), portions of a global computer network such as the Internet, or any other suitable wireline, optical, wireless, or other links.

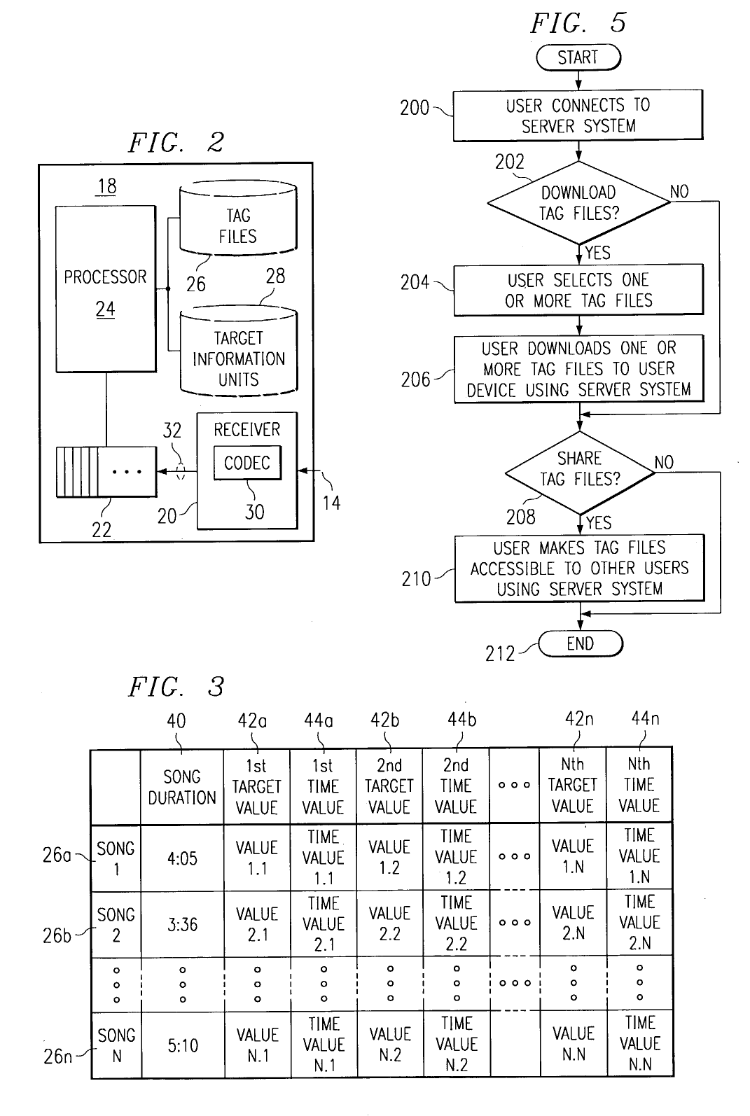

FIG. 2 illustrates an example system 18 associated with a user device 12 and supporting identification and storage of one or more target information units contained in one or more received information streams 14. In one embodiment, system 18 may include one or more receivers 20, one or more buffers 22, one or more Digital Signal Processors (DSPs) or other processors 24, one or more stored tag files 26, and one or more stored target information units 28. Each user device 12 includes a system 18, typically in addition to one or more other components depending on the nature of user device 12. For example, in addition to system 18, user device 12 may include components necessary to select and play back to the user a stored target information unit 28.

Receiver 20 receives an information stream 14 and stores a digitized data stream 30 representing the received information stream 14 in buffer 22. For example, receiver 20 may receive a digital broadcast radio signal information stream 14, such as an Internet radio broadcast, and store a digitized data stream 30 representing the received digital signal in buffer 22. The received digital signal may be stored directly in buffer 22 as digitized data stream 30 or may be processed in any suitable manner to yield digitized data stream 30. As another example, receiver 20 may receive an analog broadcast radio signal information stream 14, such as an AM or FM radio signal. To process the received analog signal for storage in buffer 22 as digitized data stream 30, receiver 20 may include an encoder/decoder (CODEC) device 30, which may be any device operable decode received information streams 14 for processing according to the present invention. For example, CODEC device 32 may be operable to convert a received analog signal to a digital format. As another example, CODEC device 32 may be an MPEG CODEC device operable to decode a received MPEG file and provide associated decompression of the digital data. Although a single receiver 20 is described for a single information stream 14, the present invention contemplates system 18 including multiple receivers 20, each operable to receive one or more information streams 14.

Buffer 22 may include any suitable memory allocated to temporarily store a digitized data stream 30 received from receiver 20. The size of buffer 22 may be selected according to any appropriate factors, and may be fixed or dynamic. For example, in one embodiment, buffer 22 may be at least the length of the longest target information unit corresponding to any stored tag file. Buffer 22 may be structured as a first in/first out (FIFO) buffer, a last in/first out (LIFO) buffer, a memory cache, or any other appropriate structure. For example, buffer 22 may store incoming digitized data stream 30 to the tail end of buffer 22 and processor 24 may read from the head of buffer 22 for processing purposes. Buffer 22 may be implemented using dynamic random access memory (DRAM), static random access memory (SRAM), nonvolatile memory, or any other suitable memory type. Although a single buffer 22 is described for a single digitized data stream 30, the present invention contemplates multiple buffers 22 for multiple digitized data streams 30, for example, one for each information stream 14.

As described above, one or more tag files 26 each represent a collection of measurable attributes corresponding to one or more target information units. Although described as files, tag files 26 may include any suitable data arrangement, and use of the term “file” herein is meant to encompass all such arrangements. FIG. 3 illustrates example tag files 26 for which the corresponding target information units are songs. Tag files 26 may also or alternatively include information for identifying and storing one or more television programs, video units, audio units, or any other suitable target information units. In the illustrated embodiment, each tag file 26 includes measurable attributes for a particular corresponding song to be identified in a received information stream 14 and stored for later playback. In another embodiment, a single tag file 26 may include measurable attributes for multiple corresponding target information units (e.g., songs). For example, a single tag file 26 may include measurable attributes for identifying all songs on a particular album. Although this description focuses primarily on tag files 26 each including measurable attributes for a single corresponding target information unit, the present invention contemplates tag files 26 including measurable attributes for multiple corresponding target information units according to particular needs.

One or more measurable attributes in tag file 26 may provide a quantitative tag by which processor 24 may identify the corresponding target information unit. For example, tag file 26a in FIG. 3 includes a duration 40, which represents the total playing time (four minutes five seconds) of the song desired to be identified and stored. Tag file 26 may also include one or more target values 42 each corresponding to a target segment of the target information unit, where each target segment has a predetermined length and where the target information unit includes one or more such target segments. The lengths of target segments may be uniform across all target information units or may vary according to particular needs and considerations. As just one example, each target value 42 may represent a measurable attribute of a five-second segment of a song. In one embodiment, certain target values 42 may be generated by applying a control algorithm or other operation to the corresponding target segment of the target information unit. For example, a control algorithm may be applied to a time sequence of amplitude values A{t} that represent a song to generate a much shorter sequence of values that help identify the song. The algorithm may be a sampling of a Fourier transform A{f} of A{t}. Alternatively, the control algorithm may be based on a discrete wavelet transform in which the song is divided into one or more time segments A {t;tᵢ} and each of the one or more time segments is further decomposed into discrete frequency components A {fⱼ,tᵢ}. As another example, a target value 42 may represent a sequence of frequencies of the corresponding target segment of the target information unit. Where the target information unit is a song, the sequence of frequencies may correspond to a sequence of notes within the song. Although particular target values 42 are discussed as examples, the present invention contemplates any suitable target values 42 according to particular needs.

In one embodiment, tag file 26 may be constructed such that each target value 42 is associated with a time value 44 registering the target value 42 with respect to the beginning of the target information unit such that it is known over what target segment of the target information unit the control algorithm or other operation was applied. For example, first target value 42a for tag file 26a (“Value 1.1”) might be generated according to a wavelet transform performed on the first five seconds of the corresponding song (“Song 1”). Second target value 42b for tag file 26a (“Value 1.2”) might be generated according to a wavelet transform performed on seconds five through ten, thirty through thirty-five, or any other five-second interval of the corresponding song (“Song 1”). Other target values 42 may represent sequences of frequencies; average tempo; any other suitable frequency, tempo, or other characteristic; or any other measurable attribute suitable for identifying the target information unit when compared with similar information in a second set of measurable attributes extracted from a portion of digitized data stream 30 representing the received information stream 14. The present invention contemplates storing in tag file 26, and identifying a target information unit according to, any number of target values 42.

A tag file 26 may be generated in any manner but is typically generated by a user according to a set of predefined guidelines for tag file construction, which may be mandatory or merely recommended. It may be preferable to establish certain mandatory requirements for information included in tag files 26, for example, to help ensure uniformity of operation of user device 12 and sharing of tag files 26 among users. For example, duration 40 of the target information unit (e.g., song duration) may be a required field in tag files 26. This may be necessary to allow system 18 to determine the location within digitized data stream 30 of the portion of digitized data stream 30 including an identified target information unit. As another example, certain target values 42 may be required fields in tag files 26 and certain mandatory requirements regarding target values 42, such as the order of target values 42, may be enforced. First target value 42a may be required to be a value generated according to a particular wavelet transform performed on a particular predetermined segment of the song (e.g., the first five seconds). Second target value 42b may be required to be a value representing a sequence of specific frequencies, the average tempo, or any other characteristics of the same predetermined segment of the song. Third target value 42c may be required to be a value generated according to the particular wavelet transform performed on another particular predetermined segment of the song (e.g., seconds five through ten, thirty through thirty-five, or any other five-second interval). A fourth target value 42d may be required to be a value representing a sequence of specific frequencies, the average tempo, or any other characteristics of the other predetermined segment of the song. Although particular examples are provided for purposes of illustration, those skilled in the art will appreciate that any appropriate target values 42 may be stored in tag files 26 and used to identify corresponding target information units according to particular needs.

Tag files 26 may include target values 42 for multiple segments (e.g., two) of a target information unit to increase the accuracy of the comparison of the second set of one or more attributes extracted from the portion of the digitized data stream with the first set of one or more attributes in tag file 26. It may be further desirable to separate the segments of the song upon which the multiple target values 42 are based to further increase the accuracy of the comparison. This may be beneficial because consecutive segments of a target information unit or segments of two different target information units may be substantially similar. Separating the multiple segments may increase the likelihood that distinct segments of the digitized data stream actually match segments of a target information unit. Furthermore, any one or more target values 42 may serve to identify a portion of digitized data stream 30 that may include the target information unit, and any one or more target values 42 may server to verify that the portion of digitized data stream 30 identified actually includes the target information unit.

Returning to FIG. 2, processor 24 may be any suitable DSP or other processor capable of identifying a target information unit in a received information stream 14, according to one or more stored tag files 26, and storing the target information unit once identified. In one embodiment, processor 24 accesses buffer 22 at predetermined intervals to extract a second set of attributes from each consecutive segment of digitized data stream 30. The predetermined intervals at which processor 24 accesses buffer 22 may have any suitable length. For example, processor 24 may access buffer 22 every five seconds to extract a second set of attributes for each five-second segment of digitized data stream 30. For example, as described above with reference to FIG. 3, the second set of attributes extracted for a segment of digitized data stream 30 may include a first test value generated by performing a control algorithm such as the wavelet transform on the segment. As another example, the second set of attributes extracted for a segment of digitized data stream 30 may include one or more other test values representing one or more sequences of frequencies within the segment, the average tempo of the segment, or any other suitable measurable attributes of the segment. In one embodiment, at least one and preferably all attributes extracted from segments of digitized data stream 30 correspond to the attributes included in tag files 26.

Processor 22 accesses the first set of attributes in a stored tag file 26, compares the second set of attributes extracted for a segment of digitized data stream 30 with the first set of attributes, and determines according to the comparison whether the segment of digitized data stream 30 corresponds to the target information unit for tag file 26. To perform the comparison, processor 24 accesses one or more first target values 42a in one or more tag files 26 and compares the first test value for the segment of digitized data stream 30 with the one or more first target values 42a in the one or more tag files 26. Processor 24 may compare the first test value with a single first target value 42a for a single tag file 26, with multiple first target values 42a for multiple tag files 26, or with all first target values 42a for all tag files 26. As discussed above, target values 42 in tag files 26 may be required fields arranged in a specified order according to rules designed to help ensure that comparisons of test values with target values 42 are meaningful. According to the comparison, processor 24 determines whether the first test value matches the one or more first target values 42a. As used herein, the term “match” is meant to encompass any suitable level of consistency, which may but need not necessarily amount to an exact match.

In one embodiment, as described above, processor 24 may perform multiple operations on the segment of digitized data stream 30. For example, processor 24 may, in addition to performing a control algorithm such as a wavelet transform on the segment, generate a second target value representing a sequence of frequencies within the segment, the average tempo of the segment, or any other suitable measurable attribute of the segment. This may result in multiple test values for the segment of digitized data stream 30 to be compared with multiple corresponding target values 42 of the same target segment. As discussed above, a match between a test value for a segment of digitized data stream 30 and a target value 42 in a tag file 26 may involve any suitable level of consistency. Furthermore, processor 24 may use any suitable standard for determining whether multiple test values match multiple target values 42 in a tag file 26. For example only and not by way of limitation, if three test values for the segment are compared with three target values 42 in a tag file 26, processor 24 may require any two of the three sets of values to match. Increasing the number of test values and target values 42 compared may increase the accuracy of the identification of a target information unit in digitized data stream 30, but may also increase processing time. Those skilled in the art will appreciate the tradeoffs between accuracy of identification and processing time and strike an appropriate balance according to particular needs.

In one embodiment, if processor 24 determines that one or more test values for a segment of digitized data stream 30 match one or more corresponding target values 42, processor 24 may attempt to verify the identification of the target information unit. Verification is not required, but may increase the probability that this determination made by processor 24 is correct. To perform the verification, processor 24 may access a second or any other subsequent segment of digitized data stream 30, separated from the first segment of digitized data stream 30 by zero or more of the predetermined intervals defining the lengths of the segments. The number of intervals separating the first and second segments within digitized data stream 30 may affect the likelihood that the verification is meaningful. For example, it is less likely that test values for multiple segments of digitized data stream 30 will match target values for the same multiple segments if digitized data stream 30 is not the target information unit. Processor 24 may extract the second set of attributes from the second segment of digitized data stream 30 in substantially the same manner as described above for the first segment. Furthermore, processor 24 may perform the comparison and resulting determination of a match in substantially the same manner as described above for the first segment. Processor 24 may perform any number of verifications, as is appropriate. It may be preferable for processor 24 to perform the verification(s) according to predefined requirements and guidelines to help ensure uniformity of operation of user device 12 and sharing of tag files 26 among users.

In one embodiment, if processor 24 successfully determines a match (possibly after verification) between a portion of digitized data stream 30 and a target information unit, processor 24 uses the first time value 44 registering the first target segment to the predetermined length of the target information unit to determine the start time of the portion of digitized data stream 30 including the target information unit. For example, the first target segment of the target information unit used to determine one or more target values 42 may always be the first five seconds of the target information unit. The first time value 44 would in this case indicate the target information unit begins at the beginning of the first target segment. Thus, according to first time value 44, processor 24 would in this case determine the beginning of the segment of digitized data stream 30 that processor 24 determined to match the first segment of the target information unit as the start of the portion of digitized data stream 30 including the target information unit. As another example, the first target segment of the target information unit used to determine one or more target values 42 may always be seconds thirty through thirty-five of the target information unit. The first time value 44 would in this case indicate the target information unit begins thirty seconds before the first target segment. Thus, according to first time value 44, processor 24 would in this case determine thirty seconds before the beginning of the segment of the target information unit as the start of the portion of digitized data stream 30 including the target information unit. Processor 24 may determine the end time for the portion of digitized data stream 30 including the target information unit by adding duration 40 to the determined start time of the portion of digitized data stream 30 including the target information unit. Processor 24 may then, using the calculated start time and end time, store the portion of digitized data stream 30 including the target information unit as a stored target information unit 28.

Each stored target information unit 28 includes a portion of a digitized data stream 30 determined by processor 24 to include a target information unit corresponding to a stored tag file 26. For example, in the specific case where user device 12 includes an MP3 player and previously received information streams 14 have included broadcast radio signals, each stored target information unit 28 may include a song contained in a broadcast radio signal that processor 32 has determined to correspond to a stored tag file 26. As another example, in the specific case where user device 12 includes a television and previously received information streams 14 have included broadcast television signals, each stored target information unit 28 may include a television program contained in a broadcast television signal that processor 32 has determined to correspond to a stored tag file 26. Memory allocated for storing target information units 28 may have any appropriate size. Factors such as cost of memory, size of system 18 and user device 12, and other suitable factors may be considered when determining the memory to allocate for storing target information units 28.

In operation of system 18, receiver 20 receives received information stream 14. As discussed above, received information stream 14 may include one or more of a broadcast radio signal, a broadcast television signal, an audio signal, a video signal, or any other suitable signal for containing a target information unit to be identified and stored according to the present invention. Furthermore, received information stream 14 may include an analog or digital signal. If received information stream 14 is a digitized data stream, receiver 20 may communicate information stream 14 as digitized data stream 30 to buffer 22. If received information stream 14 is an analog signal, receiver 20 may use CODEC device 32 to convert received information stream 14 to a digital format, communicating the resulting digitized data stream 30 representing information stream 14 to buffer 22. Providing this functionality allows system 18 to process both analog and digital received information streams 14.

At predetermined intervals, processor 24 accesses buffer 22 to extract a second set of attributes from each consecutive segment of digitized data stream 30. Processor 24 may perform a control algorithm such as a wavelet transform on the accessed segment of digitized data stream 30 to generate a first test value. Processor 24 may access one or more first target values 42a in one or more tag files 26 and may compare the first test value for the segment of digitized data stream 30 with the one or more first target values 42a in the one or more tag files 26. As discussed above, target values 42 in tag files 26 may be required fields arranged in a specified order according to rules designed to help ensure that comparisons of test values with target values 42 are meaningful. According to the comparison, processor 24 determines whether the first test value matches one or more of the first target values 42a.

In one embodiment as described above, processor 24 may perform multiple operations on the segment of digitized data stream 30, resulting in multiple test values for the segment of digitized data stream 30 to be compared with multiple corresponding target values 42 of the same test segment. As discussed above, processor 24 may use any suitable standard for determining whether multiple test values for the segment of digitized data stream 30 match multiple target values 42 in a tag file 26. Increasing the number of test values and target values 42 compared may increase the accuracy of the identification of a target information unit in digitized data stream 30, but may also increase processing time.

In one embodiment, if processor 24 determines that one or more test values for a segment of digital data stream 30 match one or more corresponding target values 42, processor 24 may attempt to verify the identification of the target information unit. Verification is not required, but may increase the probability that this determination made by processor 24 is correct. To perform verification, processor 24 may access a second or any other subsequent segment of digitized data stream 30, separated from the first segment of digitized data stream 30 by zero or more of the predetermined intervals defining the lengths of the segments. Processor 24 may extract the second set of attributes from the second segment of digitized data stream 30 in substantially the same manner as described above for the first segment. Furthermore, processor 24 may perform the comparison and resulting determination of a match in substantially the same manner as described above for the first segment. Processor 24 may perform any number of verifications, as is appropriate and preferably according to predefined requirements and guidelines.

If processor 24 successfully determines a match (possibly after verification) between a portion of digitized data stream 30 and a target information unit, processor 24 uses first time value 44 registering the first target segment to the predetermined length of the target information unit to determine the start time of the portion of digitized data stream 30 including the target information unit. Processor 24 may determine the end time for the portion of digitized data stream 30 including the target information unit by adding duration 40 to the determined start time of the portion of digitized data stream 30 including the target information unit. Processor 24 may then, using the determined start time and end time, store the portion of digitized data stream 30 including the target information unit as a stored target information unit 28.

Although identifying and storing one target information unit is described, in one embodiment system 18 operates substantially continuously to monitor information stream 14 to attempt to identify and store multiple target information units. Furthermore, where appropriate according to the implementation of system 18, system 18 may monitor multiple information streams 14. For example, if user device 12 includes an MP3 player and each information stream 14 includes a broadcast radio signal, user device 12 may monitor multiple radio frequencies to identify and store desired songs specified in one or more tag files 26. This capability may increase the probability that, and speed in which, each of the one or more target information units in each of the one or more tag files stored at user device 12 are identified and stored.

Particular embodiments of the present invention may provide one or more technical advantages. For example, certain embodiments may allow a user to store within a user device one or more tag files each representing a corresponding target information unit the user desires to store. The device may monitor one or more broadcast radio signals, for example, for desired songs corresponding to the stored tag files, recording a song contained in a broadcast radio signal if the song is determined to correspond to a stored tag file based on a comparison of attributes extracted from the radio signal with attributes in the stored tag file. This may allow a user to record one or more songs contained in one or more broadcast radio signals without requiring the user to listen to the various radio signals and personally attempt to record desired songs. This may also prevent a user from missing a desired song because it is on a radio station the user is not monitoring or missing the first few seconds of the song before beginning to record it. In certain embodiments, users may be able to share tag files with other users using a server system, expanding the number of available tag files without requiring each user to personally construct all the tag files of interest to the user or maintain all such tag files at an associated user device. Users logged in or otherwise linked to the server system may be able to share tag files in a way that allows a user to access the server system, view tag files available for selection at that time, select a tag file, and download the selected tag file to an associated user device from the server system or, through the server system, from another user device at which the selected tag file is stored. In certain embodiments, the user device can play back the target information units identified and stored at the user device as desired.

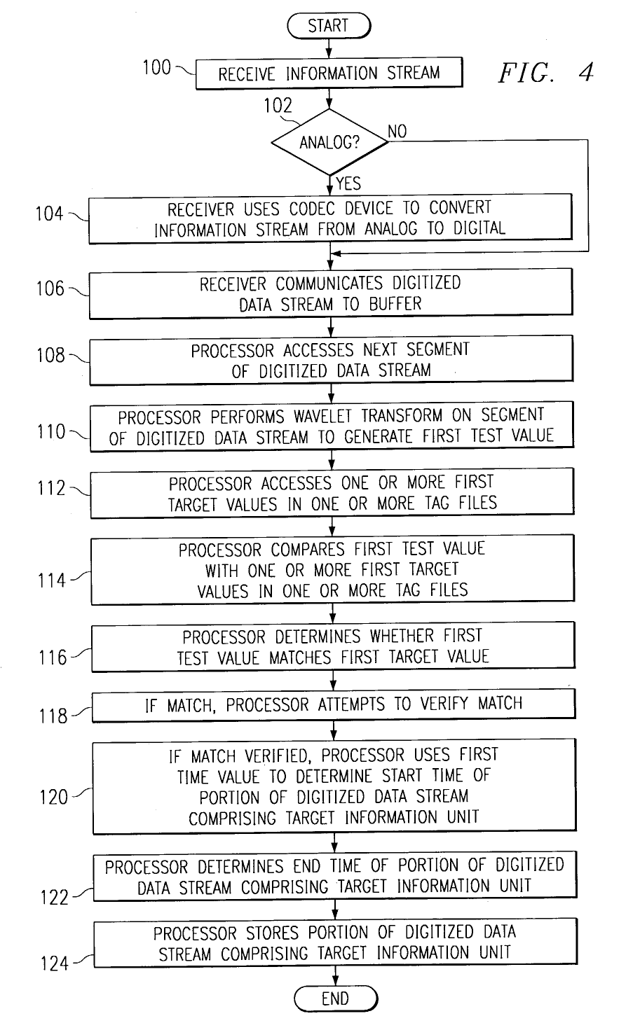

FIG. 4 illustrates an example method for identifying and storing one or more target information units contained in one or more received information streams 14. At step 100, receiver 20 receives received information stream 14. At step 102, if received information stream 14 is a digitized data stream, receiver 20 skips to step 106 and communicates information stream 14 as digitized data stream 30 to buffer 22. If received information stream 14 is an analog signal, receiver 20 uses CODEC device 32 to convert received information stream 14 to a digital format at step 104. Receiver 20 communicates the resulting digitized data stream 30 representing information stream 14 to buffer 22 at step 106.

At step 108, processor 24 accesses buffer 22 at predetermined intervals to extract a second set of attributes from each consecutive segment of digitized data stream 30. At step 110, processor 24 may perform a control algorithm such as a wavelet transform on the accessed segment of digitized data stream 30 to generate a first test value. At step 112, processor 24 accesses one or more first target values 42a in one or more tag files 26 and compares the first test value for the segment of digitized data stream 30 with the one or more first target values 42a in the one or more tag files 26 at step 114. As discussed above, target values 42 in tag files 26 may be required fields arranged in a specified order according to rules designed to help ensure that comparisons of test values with target values 42 are meaningful. According to the comparison, processor 24 determines whether the first test value matches one or more of the first target values 42a at step 116.

In one embodiment as described above, processor 24 may perform multiple operations on the segment of digitized data stream 30, resulting in multiple test values for the segment of digitized data stream 30 to be compared with multiple corresponding target values 42 of the same test segment. As discussed above, processor 24 may use any suitable standard for determining whether multiple test values for the segment of digitized data stream 30 match multiple target values 42 in a tag file 26. Increasing the number of test values and target values 42 compared may increase the accuracy of the identification of a target information unit in digitized data stream 30, but may also increase processing time.

At step 118, if processor 24 determines that one or more test values for a segment of digitized data stream 30 match one or more corresponding target values 42, processor 24 may attempt to verify the identification of the target information unit. Verification is not required, but may increase the probability that this determination made by processor 24 is correct. To perform verification, processor 24 may access a second or any other subsequent segment of digitized data stream 30 by zero or more of the predetermined intervals defining the lengths of the segments. Processor 24 may extract the second set of attributes from the second segment of digitized data stream 30 in substantially the same manner as described above for the first segment. Furthermore, processor 24 may perform the comparison and resulting determination of a match in substantially the same manner as described above for the first segment. Processor 24 may perform any number of verifications, as is appropriate and preferably according to predefined requirements and guidelines.

At step 120, if processor 24 successfully determines a match (possibly after verification) between a portion of digitized data stream 30 and a target information unit, processor 24 uses first time value 44 registering the first segment to the predetermined length of the target information unit to determine the start time of the portion of digitized data stream 30 including the target information unit. At step 122, processor 24 determines the end time for the portion of digitized data stream 30 including the target information unit by adding duration 40 to the determined start time of the portion of digitized data stream 30 including the target information unit. Using the determined start time and end time, processor 24 stores the portion of digitized data stream 30 including the target information unit as a stored target information unit 28 at step 124.

Although identifying and storing one target information unit is described, in one embodiment system 18 operates substantially continuously to monitor information stream 14 to attempt to identify and store multiple target information units. Furthermore, where appropriate according to the implementation of system 18, system 18 may monitor multiple information streams 14. For example, if user device 12 includes an MP3 player and each information stream 14 includes a broadcast radio signal, user device 12 may monitor multiple radio frequencies to identify and store songs specified in one or more tag files 26. This capability may increase the probability that, and speed in which, each of the one or more target information units in each of the one or more tag files stored at user device 12 are identified and stored.

FIG. 5 illustrates an example method for sharing and downloading one or more tag files using server system 16. At step 200, a user associated with a user device 12 connects to server system 16. The user may decide to download one or more tag files 26 at step 202. As described above with reference to FIG. 1, in one embodiment, one or more tag files 26 may be stored at server system 16. In addition, or as an alternative, one or more tag files 26 may be stored external to server system 16, at other user devices 12 associated with other users for example, such that the user may obtain one or more tag files 26 via server system 16 from another user device 12 linked at least temporarily to server system 16. If the user decides to download one or more tag files 26 at step 202, the user selects one or more tag files 26 to download at step 204. The user downloads the one or more selected tag files 26 to associated user device 12 using server system 16 at step 206. The user may decide to share one or more tag files 26 stored at the associated user device 12 at step 208. If the user decides to share one or more tag files 26, the user makes tag files 26 accessible to one or more other users using server system 16 at step 210. After the user has downloaded one or more tag files 26, shared one or more tag files 26, or both as desired, the method ends.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A system for identifying and storing a target information unit, contained in a received information stream comprising a plurality of information units, according to a stored tag file corresponding to the target information unit, comprising:
one or more stored tag files, each tag file corresponding to a target information unit having a predetermined length, each tag file comprising a first set of attributes associated with the corresponding target information unit; and
a processor operable to:
access a digitized data stream representing the received information stream;
extract a second set of one or more attributes from a portion of the digitized data stream;
compare the second set of one or more attributes extracted from the portion of the digitized data stream with the first set of one or more attributes in a stored tag file;
determine, according to the comparison of the first and second sets of attributes, whether the portion of the digitized data stream comprises the target information unit corresponding to the stored tag file; and
if the portion of the digitized data stream comprises the target information unit, store the portion of the digitized data stream comprising the target information unit, the stored portion of the digitized data stream having a length substantially equivalent to the predetermined length of the target information unit as specified in the stored tag file for the target information unit.

2. The system of claim 1, wherein the received information stream comprises one or more of:
a broadcast radio signal, the target information unit comprising a song, the predetermined length being the length of the song;
a broadcast television signal, the target information unit comprising a television program, the predetermined length being the length of the television program;
an audio signal, the target information comprising an audio segment, the predetermined length being the length of the audio segment; and
a video signal, the target information unit comprising a video segment, the predetermined length being the length of the video segment.

3. The system of claim 1, wherein the one or more tag files have been obtained from one or more sources external to the system and downloaded for storage using one or more server systems.

4. The system of claim 1, wherein:
the first set of attributes in the stored tag file comprises a value for a first target segment of the target information unit generated according to a wavelet transform performed on data representing the first target segment, the first set of attributes further comprising a first time value registering the first target segment to the beginning of the target information unit;
the second set of attributes extracted from the portion of the digitized data stream comprises a value for a first test segment of the portion of the digitized data stream generated according to a wavelet transform performed on the first test segment; and
determining comprises comparing the value for the first test segment with the value for the first target segment to identify the target information unit within the portion of the digitized data stream.

5. The system of claim 4, wherein:
determining whether the portion of the digitized data stream comprises the target information unit corresponding to the stored tag file comprises determining whether one or more attributes of the first test segment match one or more attributes of the first target segment; and
storing comprises:
identifying the beginning of the target information unit within the digitized data stream according to the first time value in the first set of attributes;
identifying the end of the target information unit within the digitized data stream according to the predetermined length in the first set of attributes; and
storing the portion of the digitized data stream between the beginning and the end of the target information unit.

6. The system of claim 5, wherein a match comprises an exact match.

7. The system of claim 4, wherein:
the first test segment of the portion of the digitized data stream is one of a plurality of consecutive test segments of the portion of the digitized data stream, each test segment having an identical predetermined length; and
the processor is further operable to:
for each consecutive test segment, generate a value for the test segment according to a wavelet transform performed on the test segment; and
compare the value for each consecutive test segment with the value for the target segment of the target information unit, generated according to a wavelet transform performed on data representing the target segment, to determine whether the value for the test segment matches the value for the target segment.

8. The system of claim 4, wherein:
the first set of attributes in the stored tag file further comprises a value for a second target segment of the target information unit generated according to a wavelet transform performed on data representing the second target segment, the first set of attributes further comprising a second time value registering the second target segment to the beginning of the target information unit;
the second set of attributes extracted from the portion of the digitized data stream further comprises a value for a second test segment of the portion of the digitized data stream generated according to a wavelet transform performed on the second test segment; and
the process is further operable to, if a match is determined between the value for the first test segment and the value for the first target segment, compare the value for the second test segment to the value for the second target segment to verify the identification of the target information unit within the portion of the digitized data stream.

9. The system of claim 1, wherein:
the first set of attributes in the stored tag file comprises a sequence of frequencies within a target segment of the target information unit, the first set of attributes further comprising a time value registering the first target segment to the beginning of the target information unit;
the second set of attributes extracted from the portion of the digitized data stream comprises a sequence of frequencies within a test segment of the portion of the digitized data stream; and
determining comprises comparing the sequence of frequencies of the test segment with the sequence of frequencies of the target segment to identify the target information unit within the portion of the digitized data stream.

10. The system of claim 9, wherein the received information stream is a radio broadcast, the target information unit is a song, and the frequencies represent notes in the song.

11. The system of claim 9, wherein:
determining whether the portion of the digitized data stream comprises the target information unit corresponding to the stored tag file comprises determining whether one or more attributes of the test segment match one or more attributes of the target segment; and
storing comprises:
identifying the beginning of the target information unit within the digitized data stream according to the time value in the first set of attributes;
identifying the end of the target information unit within the digitized data stream according to the predetermined length in the first set of attributes; and
storing the portion of the digitized data stream between the beginning and the end of the target information unit.

12. The system of claim 9, wherein:
the first test segment of the portion of the digitized data stream is one of a plurality of consecutive test segments of the portion of the digitized data stream, each test segment having an identical predetermined length; and
the processor is further operable to:
for each consecutive test segment, extract a sequence of frequencies within the test segment; and
compare the sequence of frequencies within each consecutive test segment with the sequence of frequencies within the target segment of the target information unit to determine if the sequence of frequencies within the test segment matches the sequence of frequencies within the target segment.

13. The system of claim 1, wherein the system further comprises an encoder/decoder (CODEC) device and the received information stream comprises an analog signal, the CODEC device operable to:
receive the analog signal;
convert the analog signal to a digitized data stream; and
communicate the digitized data stream for storage in a location accessible to the processor.

14. The system of claim 13, wherein the CODEC device is a Motion Picture Expert Group (MPEG) CODEC device.

15. A method for identifying and storing a target information unit, contained in a received information stream comprising a plurality of information units, according to a stored tag file corresponding to the target information unit, comprising:
accessing one or more stored tag files, each tag file corresponding to a target information unit having a predetermined length, each tag file comprising a first set of attributes associated with the corresponding target information unit;
accessing a digitized data stream representing the received information stream;
extracting a second set of one or more attributes from a portion of the digitized data stream;
comparing the second set of one or more attributes extracted from the portion of the digitized data stream with the first set of one or more attributes in a stored tag file;
determining, according to the comparison of the first and second sets of attributes, whether the portion of the digitized data stream comprises the target information unit corresponding to the stored tag file; and
if the portion of the digitized data stream comprises the target information unit, storing the portion of the digitized data stream comprising the target information unit, the stored portion of the digitized data stream having a length substantially equivalent to the predetermined length of the target information unit as specified in the stored tag file for the target information unit.

16. The method of claim 15, wherein the received information stream comprises one or more of:
a broadcast radio signal, the target information unit comprising a song, the predetermined length being the length of the song;
a broadcast television signal, the target information unit comprising a television program, the predetermined length being the length of the television program;
an audio signal, the target information comprising an audio segment, the predetermined length being the length of the audio segment; and
a video signal, the target information unit comprising a video segment, the predetermined length being the length of the video segment.

17. The method of claim 15, further comprising obtaining the one or more tag files from one or more sources external to the system and downloading the one or more tag files from one or more sources external to the system for storage using one or more server systems.

18. The method of claim 15, wherein:
the first set of attributes in the stored tag file comprises a value for a first target segment of the target information unit generated according to a wavelet transform performed on data representing the first target segment, the first set of attributes further comprising a first time value registering the first target segment to the beginning of the target information unit;
the second set of attributes extracted from the portion of the digitized data stream comprises a value for a first test segment of the portion of the digitized data stream generated according to a wavelet transform performed on the first test segment; and
determining comprises comparing the value for the first test segment with the value for the first target segment to identify the target information unit within the portion of the digitized data stream.

19. The method of claim 18, wherein:
determining whether the portion of the digitized data stream comprises the target information unit corresponding to the stored tag file comprises determining whether one or more attributes of the first test segment match one or more attributes of the first target segment; and
storing comprises:
identifying the beginning of the target information unit within the digitized data stream according to the first time value in the first set of attributes;
identifying the end of the target information unit within the digitized data stream according to the predetermined length in the first set of attributes; and
storing the portion of the digitized data stream between the beginning and the end of the target information unit.

20. The method of claim 19, wherein a match comprises an exact match.

21. The method of claim 18, wherein the first test segment of the portion of the digitized data stream is one of a plurality of consecutive test segments of the portion of the digitized data stream, each test segment having an identical predetermined length, the method further comprising:
for each consecutive test segment, generating a value for the test segment according to a wavelet transform performed on the test segment; and
comparing the value for each consecutive test segment with the value for the target segment of the target information unit, generated according to a wavelet transform performed on data representing the target segment, to determine whether the value for the test segment matches the value for the target segment.

22. The method of claim 18, wherein:
the first set of attributes in the stored tag file further comprises a value for a second target segment of the target information unit generated according to a wavelet transform performed on data representing the second target segment, the first set of attributes further comprising a second time value registering the second target segment to the beginning of the target information unit;
the second set of attributes extracted from the portion of the digitized data stream further comprises a value for a second test segment of the portion of the digitized data stream generated according to a wavelet transform performed on the second test segment; and
the method further comprises, if a match is determined between the value for the first test segment and the value for the first target segment, comparing the value for the second test segment to the value for the second target segment to verify the identification of the target information unit within the portion of the digitized data stream.

23. The method of claim 15, wherein:
the first set of attributes in the stored tag file comprises a sequence of frequencies within a target segment of the target information unit, the first set of attributes further comprising a time value registering the first target segment to the beginning of the target information unit;
the second set of attributes extracted from the portion of the digitized data stream comprises a sequence of frequencies within a test segment of the portion of the digitized data stream; and
determining comprises comparing the sequence of frequencies of the test segment with the sequence of frequencies of the target segment to identify the target information unit within the portion of the digitized data stream.

24. The method of claim 23, wherein the received information stream is a radio broadcast, the target information unit is a song, and the frequencies represent notes in the song.

25. The method of claim 23, wherein:
determining whether the portion of the digitized data stream comprises the target information unit corresponding to the stored tag file comprises determining whether one or more attributes of the test segment match one or more attributes of the target segment; and
storing comprises:
identifying the beginning of the target information unit within the digitized data stream according to the time value in the first set of attributes;
identifying the end of the target information unit within the digitized data stream according to the predetermined length in the first set of attributes; and
storing the portion of the digitized data stream between the beginning and the end of the target information unit.

26. The method of claim 23, wherein the first test segment of the portion of the digitized data stream is one of a plurality of consecutive test segments of the portion of the digitized data stream, each test segment having an identical predetermined length, the method further comprising:
for each consecutive test segment, extracting a sequence of frequencies within the test segment; and
comparing the sequence of frequencies within each consecutive test segment with the sequence of frequencies within the target segment of the target information unit to determine if the sequence of frequencies within the test segment matches the sequence of frequencies within the target segment.

27. The method of claim 15, wherein the system further comprises an encoder/decoder (CODEC) device and the received information stream comprises an analog signal, the CODEC device operable to:
receive the analog signal;
convert the analog signal to a digitized data stream; and
communicate the digitized data stream for storage in a location accessible to the processor.

28. The method of claim 27, wherein the CODEC device is a Motion Picture Expert Group (MPEG) CODEC device.

29. A system for identifying and storing a target song, contained in a broadcast radio signal comprising a plurality of songs, according to a stored tag file corresponding to the target song, comprising:
one or more stored tag files, each tag file corresponding to a target song having a predetermined length, each tag file having been obtained from a source external to the system and downloaded for storage using one or more server systems, each tag file comprising a target value associated with a target segment of the corresponding target song, the target value having been generated according to a control algorithm performed on data representing the target segment associated with the target value, the target value further associated with a time value registering the target segment associated with the target value to the beginning of the target song; and
a processor operable to:
access a digitized data stream representing the received broadcast radio signal, the digitized data stream comprising a plurality of consecutive test segments, each test segment having an identical predetermined length;
generate, for each consecutive test segment, a test value for the test segment by performing the control algorithm on the test segment;
compare the test value for each consecutive test segment with the target value;
determine, according to the comparison of the test value for a test segment with the target value, whether a portion of the digitized data stream comprising the test segment the target song; and
if the portion of the digitized data stream comprising the test segment comprises the target song, identifying the beginning of the target song within the digitized data stream according to the time value associated with the target value, identifying the end of the target song within the digitized data stream according to the predetermined length of the target song based on the identified beginning of the target song within the digitized data stream, and storing the portion of the digitized data stream between the identified beginning and identified end of the target song within the digitized data stream, the stored portion of the digitized data stream having a length substantially equivalent to the predetermined length of the target song.
